(19) United States
(12) Patent Application Publication
(10) Pub. No.: US 2002/0120525 A1
(43) Pub. Date: Aug. 29, 2002

(54) Method and system for configuring automotive emissions-control systems

(76) Inventors: Peter Floerchinger, Wiesbaden (DE); Achim K. Heibel, Rotterdam (NL); Kevin P. Julien, Painted Post, NY (US); Mansour Masoudi, Painted Post, NY (US); Matthew A. Strack, Horseheads, NY (US); Paul M. Then, Corning, NY (US)

Correspondence Address: CORNING INCORPORATED, SP-TI-3-1, CORNING, NY, 14831

(21) Appl. No.: 09/794,871

(22) Filed: Feb. 27, 2001

(51) Int. Cl. G06F 17/60

(52) U.S. Cl. 705/26

(57) ABSTRACT

A method and system for configuring an automotive emissions-control system via the Internet. A user submits an emissions-control system profile which includes fluid flow conditions, substrate parameters, and canning conditions. The supplier Web site system receives the emissions-control system profile and performs a pressure drop calculation, transmitting the results to the customer computer. If pressure drop results are within the range targeted by the user, the user selects that the customer system send a request to the supplier Web site system to provide a selection of all the products from the supplier's product database which satisfy the pressure drop conditions. The user then requests additional information on a specific product or on placing an order. The supplier Web site system directs the request to a supplier representative for processing.

### BACKGROUND OF THE INVENTION

The present invention relates to a method and system for assisting a customer with configuring emissions-control solutions, and, more particularly, to a method and system for enabling a customer to design and validate an automotive emissions-control system and to select catalytic converter substrates and particulate filters over the Internet.

In the automotive industry, car manufacturers (customers) rely on manufacturers of pollution control system components (suppliers) to provide them with products that best meet their specific emissions-control system requirements. Usually this process involves frequent interactions between the customer and the supplier, in which the customer gives the supplier a set of conditions for which the supplier must determine, through extensive calculations, what available products are most suitable.

This process has several problems associated with it. One being that it is manually intensive, requiring numerous meetings and/or electronic & manual communication to obtain requirements/conditions, discuss issues and communicate results, resulting in an inefficient and costly process which burdens the resources of both the customer and the supplier. Another problem is that the customer often designs emissions-control system prior to contacting the supplier without full knowledge of the supplier's products or manufacturing capabilities only to learn later if the design requirements can be met.

It would be advantageous to obtain a method and system for configuring automotive emissions-control solutions more efficiently and cost-effectively. The present invention addresses this need.

### SUMMARY OF INVENTION

The present invention utilizes a private or public computer network such as the Internet and the World Wide Web to facilitate an efficient, reliable, and cost-effective method and system for designing, selecting and validating emissions-control system parameters and identifying emissions-control solutions for specific automotive designs.

An embodiment of the present invention provides a method and system for configuring catalytic converter substrates for gasoline engines from a remote customer computer. The customer (user) inputs an emissions-control system profile which includes exhaust or fluid flow conditions, substrate parameters, and canning conditions into the customer computer, which then displays information that identifies suitable, application-specific, catalytic converter substrates available from the supplier.

The supplier Web site system receives and stores the emission-control system profile of the user, performs a pressure drop calculation, and provides the results to the customer computer. The customer computer displays an indication of an action that the user is to perform to view a selection of products that satisfy the results generated. When requested by the customer computer, the supplier Web site system provides information on suitable emissions-control products made by the supplier.

The customer computer displays an indication of an action that the user is to perform to receive additional information from the supplier on the product itself and/or information on placing an order. The customer computer sends the message to the supplier Web site system requesting further information. The supplier Web site system processes the message, provides the customer with a Web page that confirms receipt of the customer's request, and transmits the user's request to a supplier representative. Then the supplier representative contacts the user at a later time, either electronically or physically to provide the information that was requested.

If the user is not satisfied with the pressure drop results or with the products available, the customer computer displays an indication of an action that the user is to perform to configure another product using a different emissions-control system profile.

### BRIEF DESCRIPTION OF THE DRAWINGS

FIG. 1 is a block diagram showing the components of the present invention;

FIG. 2 is a flow diagram showing the steps for configuring an emissions-control system according to the present invention;

FIG. 3 is an example of a Web page in which a user must log in or a new user must apply for an account to gain access to the supplier system;

FIG. 4 is an example of a Web page displayed on the customer computer after the user logs in to the supplier system;

FIG. 5 is an example of a Web page showing an Online Registration Form for new users;

FIG. 6 is an example of a Web page in which the user enters engine fluid flow conditions according to the present invention;

FIG. 7 is an example of a Web page in which the user enters catalytic converter substrate parameters according to the present invention;

FIG. 8 is an example of a Web page in which the user enters canning conditions according to the present invention;

FIG. 9 is an example of a Web page, which displays the results of the calculation performed by the calculator engine;

FIG. 10 is an example of Web page, which displays the results performed by the product selector;

FIG. 11 is an example of Web page which is displayed on the customer computer, when the user requests more information on a desired catalytic converter substrate from FIG. 9.

### DETAILED DESCRIPTION OF INVENTION

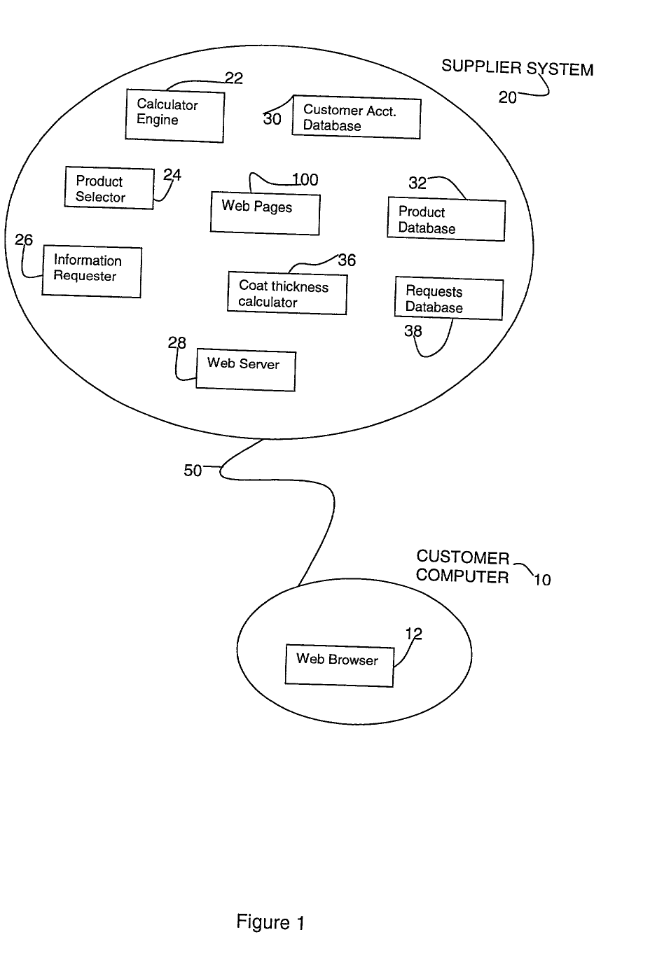

Referring to FIG. 1, therein illustrated are the components of the present invention. The customer computer 10 includes a web browser 12 such as Netscape's Navigator or Microsoft's Internet Explorer which communicates with the Web server 28 of the supplier system 20 over a public network 50 such as the Internet.

The supplier Web site system 20 includes a calculator engine 22, a product selector 24, an information requester 26, a web server 28, a customer account database 30, a product database 32, a requests database 34, a coat thickness calculator 36, and a plurality of Web pages 100. The calculator engine 22 is a program, which validates the parameters of an emissions-control system by calculating the pressure drop across the system based on an a profile including fluid flow conditions, substrate parameters and canning conditions as defined by a user. The product selector 24 is a program that matches the supplier's product database 32 against the results data generated by the calculator engine 22. The product requester 26 is a program that sends an electronic message informing a designated supplier representative that a user is interested in obtaining further information on the supplier's products, including information about placing an order.

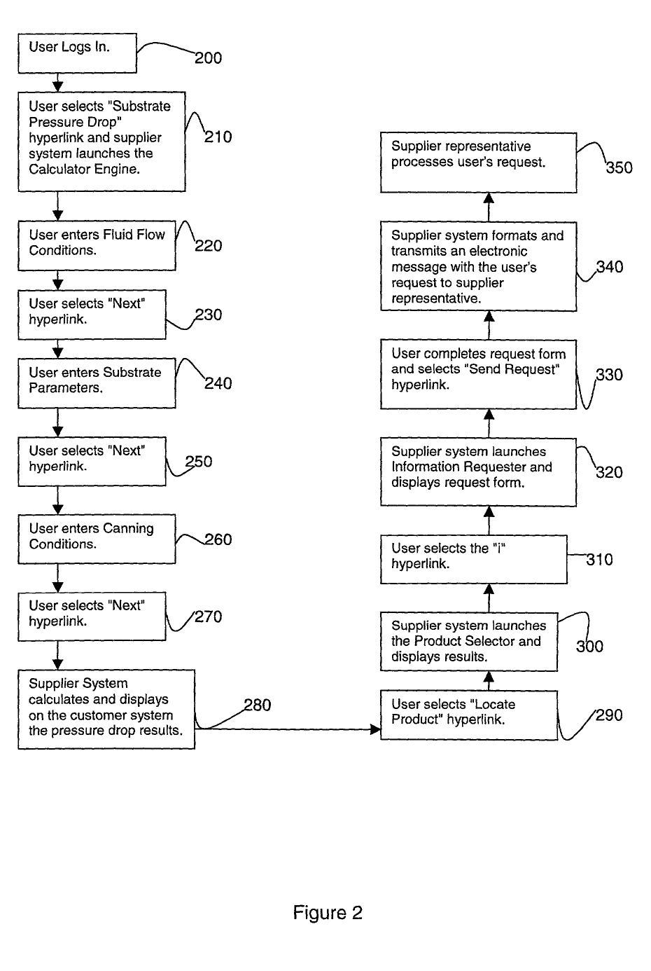

FIG. 2 is a flow diagram, which shows the steps of a method of configuring an automotive catalytic converter substrate for a gasoline engine emissions-control system, according to the present invention.

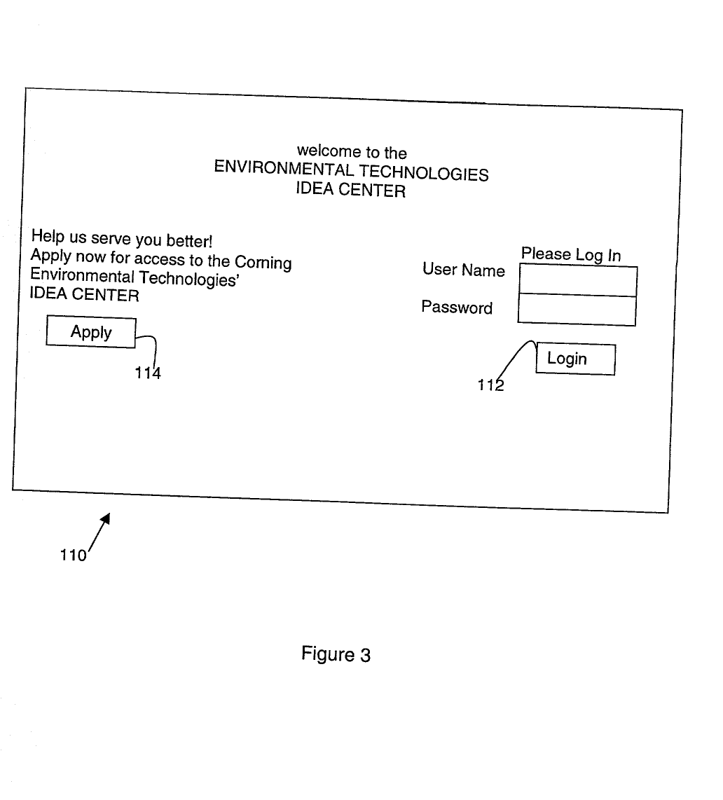

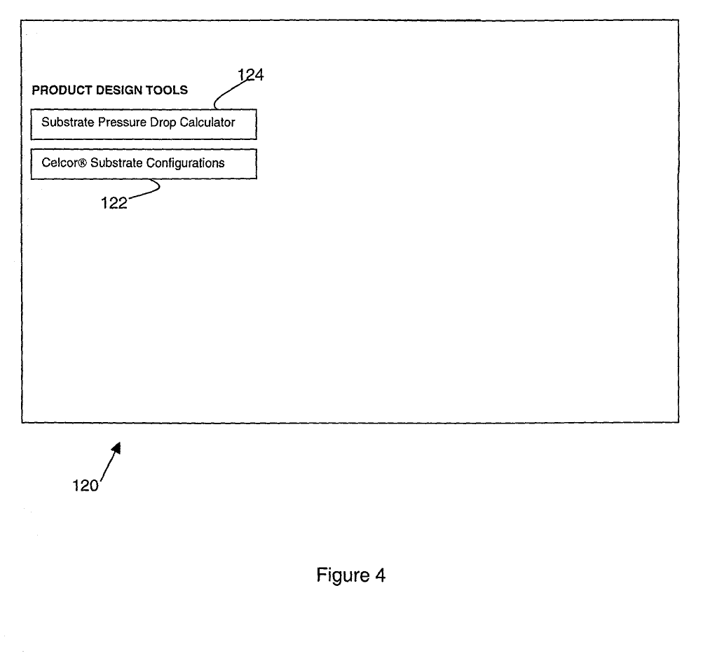

In step 200 a user logs in, to the supplier system 20 by entering the user name and password and then selecting the “Login” hyperlink 112 on Web page 110, which is illustrated in FIG. 3. The supplier system 20 verifies the customer account information against the customer account database 26, and then the supplier system 20 provides the customer computer 10 with a new Web page 120 as illustrated in FIG. 4.

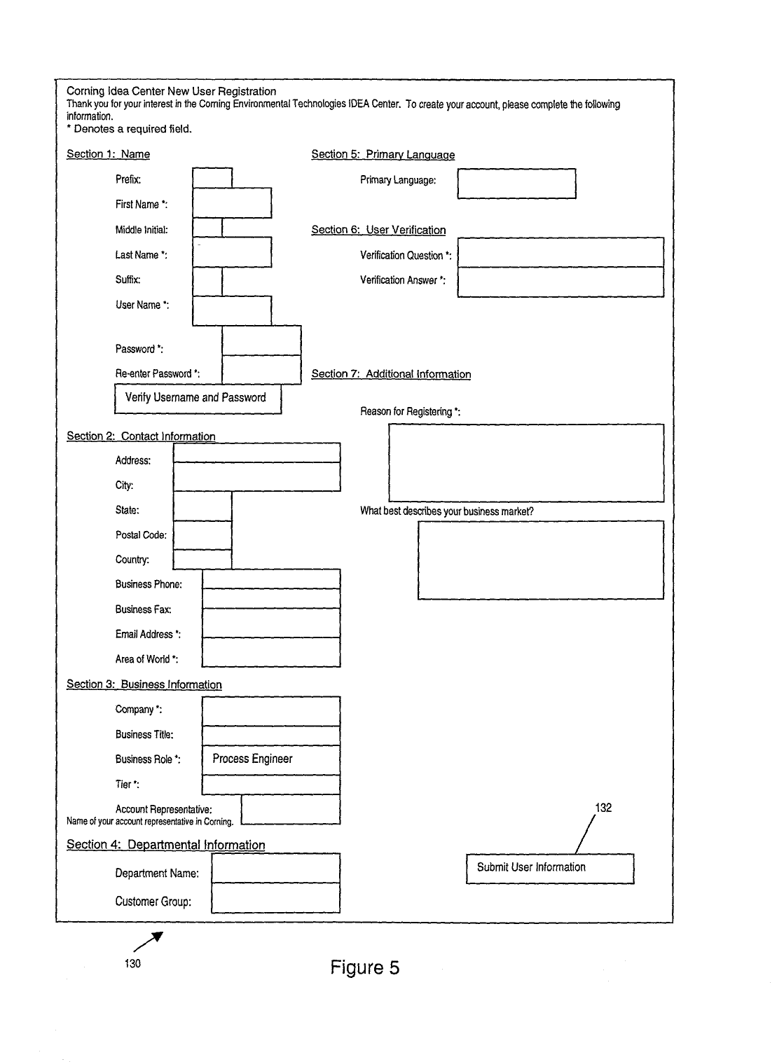

Before gaining access to the supplier system 20, a new user may be asked to create an account by selecting the “Apply” hyperlink 114 from Web page 110. In a preferred embodiment, granting of access is at the discretion of the supplier. FIG. 5 displays an example of an Online Registration Form 130, which a new user completes; the registration form specifies legal terms for using the supplier system 20. The Online Registration Form 130 is provided as an example only, and one skilled in the art would appreciate that the registration process can have many alternatives. Once the registration form is completed, the new user selects the “Submit User Information” hyperlink 132 to submit the information. The application, which displayed the registration form 130, creates an electronic message which is sent to the appropriate supplier representative. If the supplier representative deems that access should be granted to the requesting individual, an internal authorization program is run and the customer account is activated. At the point of activation, the authorization program sends an electronic message to the original requesting new user, indicating that their account is now active and available for use.

After accessing the supplier system 20, in step 210 the user selects the “Substrate Pressure Drop Calculator” hyperlink 122 to launch the calculator engine 22. On the same Web page 120, the user can select “Celcor® Substrate Configurations” hyperlink 124 to obtain more information on the catalytic converter products available from the supplier.

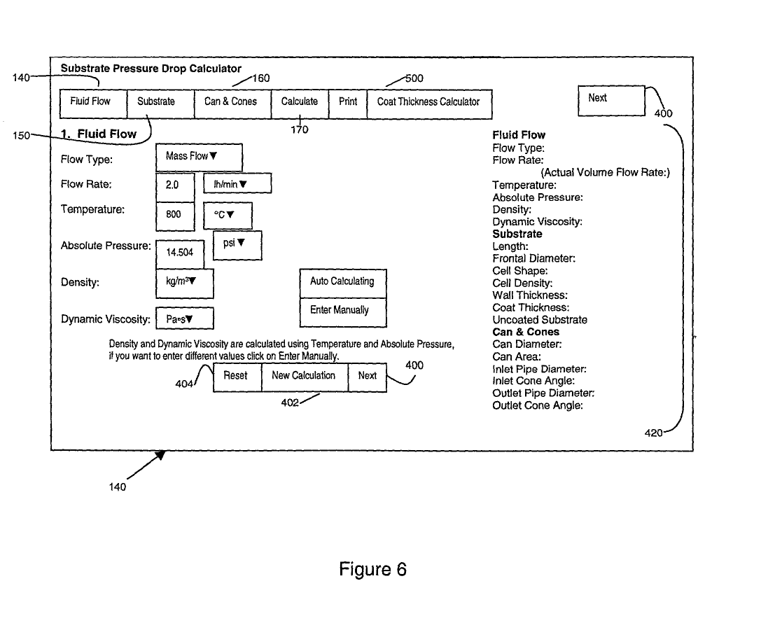

In response to the action performed in step 210, the customer computer 10 sends a message to the supplier system 20 which in turn provides the customer computer 10 with a new Web page 140 as illustrated in FIG. 6. The user, in step 220, enters target engine fluid flow conditions including exhaust flow type and rate, temperature, absolute pressure, density and dynamic viscosity. Then in step 230 the user selects the “Next” hyperlink 400 to proceed with the next segment.

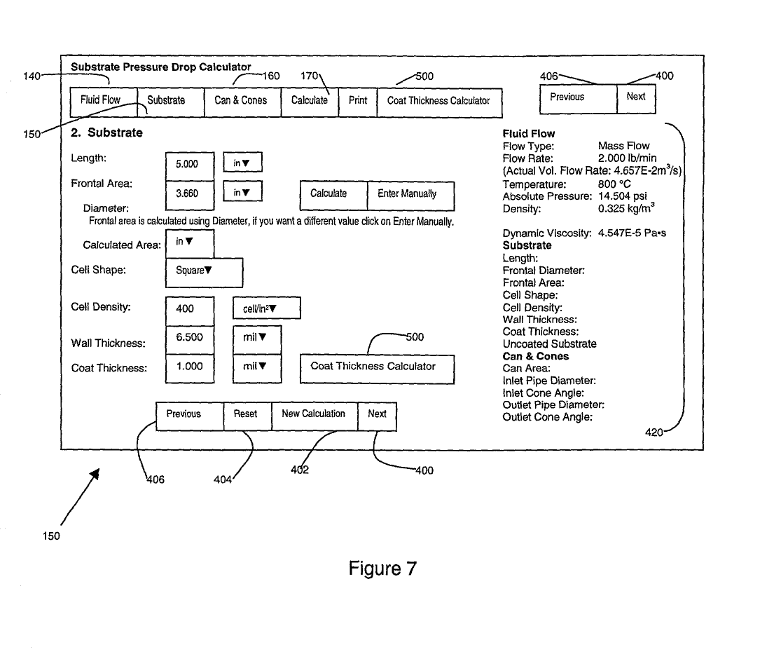

In response to this action the supplier system 20 provides the customer computer 10 with a new Web page 150 as illustrated in FIG. 7. Here the user enters substrate parameters including length, frontal area, cell shape, cell density, wall thickness and coat thickness (step 240). The Coat Thickness Calculator 36 is provided as a tool to guide users in calculating the coat thickness, and can be accessed by selecting the “Coat Thickness Calculator” hyperlink 500.

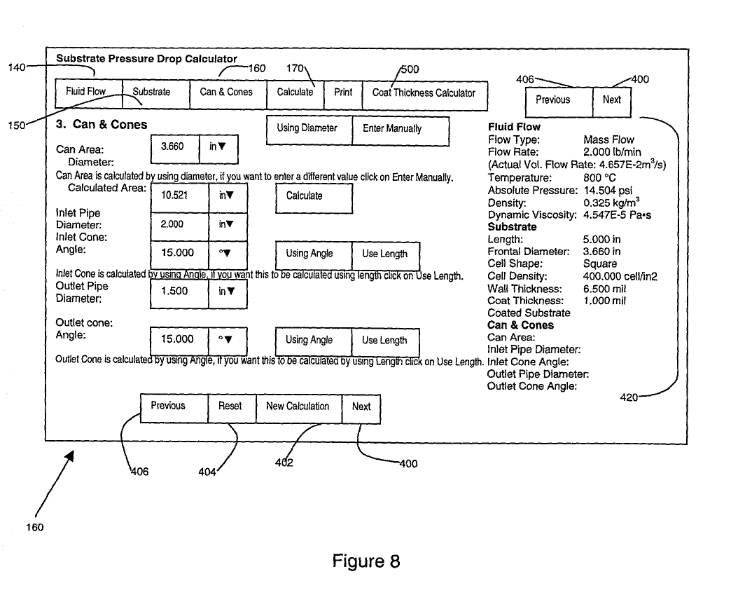

In step 250 the user selects the “Next” hyperlink 400 on Web page 150. In response to this action the supplier system 20 provides the customer computer 10 with a new Web page 160 as illustrated in FIG. 8, in which the user enters target canning conditions including can area, inlet and outlet pipe diameters and inlet and outlet cone angles (step 260).

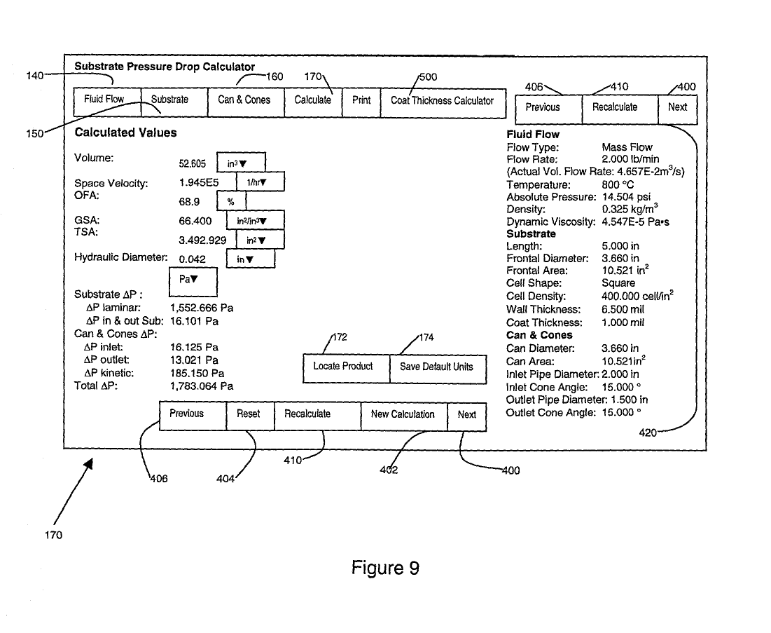

Then, in step 270 the user selects either the “Next” hyperlink 400 or the “Calculate” hyperlink 170 from Web page 160. In response to this action, in step 280, the Web server 28 uses the calculator engine 22 program to calculate the pressure drop of an emissions control system based on the fluid flow conditions, substrate parameters and canning conditions entered by the user in Web pages 140, 150 and 160. The Web Server 28 then returns a new Web page 170 (FIG. 9) to the customer computer 10, which displays input summary and system pressure drop results. The pressure drop is a measure of the conversion efficiency of the catalytic converter substrate and therefore of the efficiency of the emissions-control system and ultimately of the engine. The user can determine based on the pressure drop data, whether the profile conditions entered in Web pages 140, 150 and 160 provide a suitable emissions-control system for the desired automotive platform.

If the resulting pressure drop data is within a suitable range as determined by the user, then in step 290 the user can view a list of the catalytic converter substrates based on the profile generated by the calculator engine 22, by selecting the “Locate Product” Hyperlink 174. (The user can also save their current set of operating units by selecting the “Save Default Units” hyperlink 172).

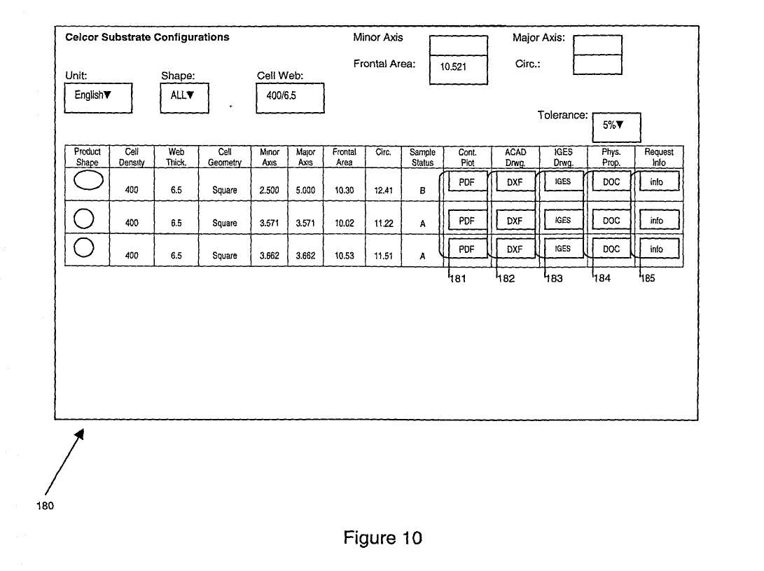

In step 300, the supplier system 20 initiates the product selector 24 program to search the product database 32, and selects suitable automotive catalytic converter substrates which satisfy the pressure drop results. The product selection is then provided on the computer system 10 in a new Web page 180 as illustrated FIG. 10.

Each product displayed on Web page 180 has several hyperlinks (181-184) associated with it. By selecting any or all of these hyperlinks, the client can obtain additional information on the product including 2D geometric plots, CAD files, and physical properties.

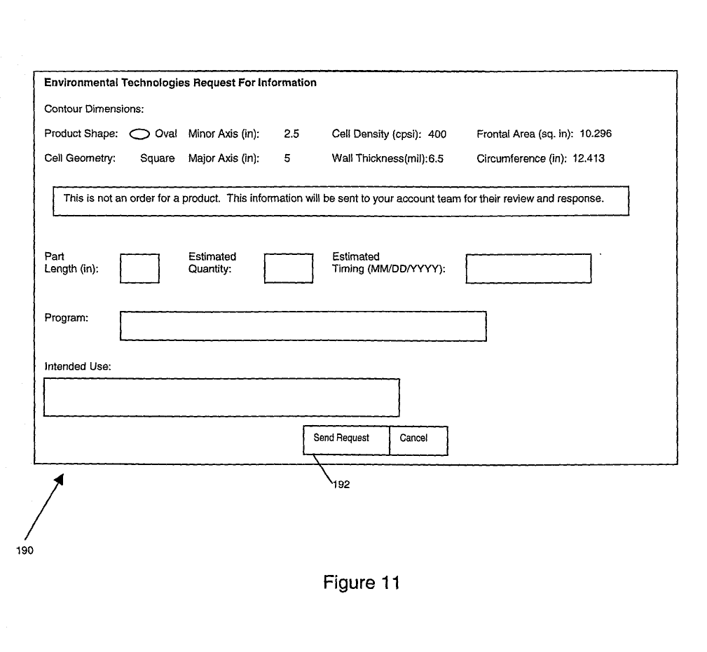

By selecting the “i” hyperlink 185, the user can request more information on the associated product or can request information about placing an order (step 310). In response to this action, the supplier system 20 in step 320 launches the Information Requester 26 program and displays a new Web page 190 (FIG. 11) on the customer computer 10. The user is asked to provide information about the specific length of the substrate, the estimated quantity and time, and the intended use of the product (step 330). Then, the user selects the “Send Request” hyperlink 192 to submit the information to the supplier system 20.

In response to this action, in step 340, the Information Requester 26 automatically formats and transmits an electronic message to the e-mail of a designated representative of the supplier. The supplier representatives processes the request, and contacts the user either manually (i.e., via the telephone) or electronically (i.e., via electronic mail) (step 350). As a result of this contact, the information is provided to the requesting user and/or an order could be placed. Web pages 140-190, illustrated in FIGS. 6-11, are provided with an exemplary profile as a user might enter and resulting data. This example is intended for illustration purposes and not as a limitation on the present invention.

If the pressure drop results generated in step 280 are not satisfactory to the user, the user may perform another calculation with another set of emissions-control conditions by selecting the “New Calculation hyperlink” 402 or the “Recalculate” hyperlink 410 on Web page 170. The user then repeats steps 200-350.

Web pages 140-170 also display a section 420, which summarizes the conditions and parameters entered into the calculator engine 22 by the user, during each step. Web pages 140-170 and 500 also display additional hyperlinks which include a “Reset” hyperlink 404 and a “Previous” hyperlink 406, as well as a set of hyperlinks for each web page. One of ordinary skill in the art will appreciate these sections may be changed or modified appropriately.

An advantage of the present invention is that it provides an efficient, reliable and cost-effective process for designing and validating an emissions-control system by utilizing a public network such Internet and the World Wide Web, the process including accepting a network transmitted emissions-control system profile and in response transmitting pressure drop results; accepting a network transmitted product selection request and in response transmitting a selection of products based on the pressure drop results; accepting a network transmitted request for additional product and ordering information, and, in response providing the requested product and ordering information.

Another advantage of the present invention is that it allows a user to move from a series of design considerations, directly into examining potential solutions to those design considerations.

The ability for the customer to view the product database of the supplier also provides the advantage of preventing wasteful time and activities pursuing design solutions, which are not part of the supplier's current capabilities or product set.

While the preferred embodiment of the present invention has been described in connection with automotive catalytic converter substrates, it will be appreciated that the present invention can also be used with other similar products such as diesel particulate filters. Therefore, in another embodiment the product database 32 would not only include automotive catalytic converter substrates but also diesel particulate filters.

More generally, although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method for assisting a customer in configuring an automotive emissions-control system, the method comprising:
providing a supplier computer system which communicates with a customer computer over a public network;
submitting an emissions-control system profile from the customer computer to the supplier system;
sending a request to the supplier system to calculate the pressure drop of the emissions-control system profile;
transmitting to the customer computer a Web page comprising the pressure drop results;
sending a request to the supplier system for a selection of products which satisfy the pressure drop results;
transmitting to the customer computer a Web page comprising the products selection;
sending a request to the supplier system for additional information;
providing the requested information.

2. The method of claim 1 wherein the public network is the Internet.

3. The method of claim 1 wherein submitting an emissions-control system includes submitting exhaust flow conditions, substrate parameters and canning conditions.

4. The method of claim 1 wherein products are selected from a product database comprising catalytic converter substrates.

5. The method of claim 1 wherein products are selected from a product database comprising diesel particulate filters.

6. The method of claim 1 wherein requesting additional information includes requesting information about placing an order.

7. The method of claim 6 further comprising:
in response to the request for additional information, transmitting to the customer computer a receipt of the request, and formatting an electronic message containing the request for additional information for sending to a supplier representative.

8. The method of claim 7 wherein the supplier representative contacts a user of the customer computer electronically with the requested information.

9. The method of claim 7 wherein the supplier representative contacts a user of the customer computer manually with the requested information.

10. A method for enabling a customer to design and validate emissions-control systems, the method comprising:
accepting a network transmitted emissions-control system profile;
in response transmitting pressure drop results;
accepting a network transmitted product selection request; and,
in response transmitting a selection of products based on the pressure drop results.

11. The method of claim 10 wherein the network communication is over the Internet.

12. The method of claim 11 wherein the transmitted emissions-control system profile includes exhaust flow conditions, substrate parameters and canning conditions.

13. The method of claim 12 wherein the selection of products is selected from the group consisting of catalytic converter substrates and diesel particulate filters.

14. The method of claim 13 further comprising:
accepting a network transmitted request for additional product and ordering information; and,
in response providing the requested product and ordering information.

15. The method of claim 14 wherein the requested product and ordering information is provided electronically.

16. The method of claim 14 wherein the requested product and ordering information is provided manually.

17. A supplier system comprising:
a calculator engine that in response to an action performs a pressure drop calculation based on an emissions-control system profile;
a product selector that in response to an action selects products from a supplier product database which satisfy the pressure drop results; and,
an information requester that in response to an action formats and transmits a request for additional product and order information to a representative of the supplier.

18. The supplier Web system of claim of claim 17 wherein the emissions-control system profile comprises exhaust flow conditions, substrate parameters and canning conditions.

19. The supplier Web system of claim 18 wherein the product database comprises products selected from the group consisting of catalytic converter substrates and diesel particulate filters.

20. The supplier Web system of claim 18 further comprising a coat thickness calculator that in response to an action calculates the thickness of a substrate coating.

21. A method for facilitating the design and validation of automotive emissions-control solutions, the method comprising providing a network-accessible computer system including a calculator engine that in response to an action performs a pressure drop calculation based on an emissions-control system profile, a product selector that in response to an action selects products from a supplier product database which satisfy the pressure drop results, and, an information requester that in response to an action formats and transmits a request for additional product and order information to a representative of the supplier.
